(19) United States
(12) Patent Application Publication
(10) Pub. No.: US 2018/0058293 A1
(43) Pub. Date: Mar. 1, 2018

(54) Reduced Sulfation Impact on Cu-SCRs

(71) Applicant: JOHNSON MATTHEY PUBLIC LIMITED COMPANY, LONDON (GB)

(72) Inventors: Per MARSH, Gothenburg (SE); Andrew NEWMAN, Royston (GB); Christopher SMITH, Royston (GB)

(21) Appl. No.: 15/685,496

(22) Filed: Aug. 24, 2017

Related U.S. Application Data
(60) Provisional application No. 62/379,417, filed on Aug. 25, 2016.

(51) Int. Cl. F01N 3/20; F01N 3/08; F01N 3/10; F01N 3/035; F01N 13/00; B01D 53/94; B01J 29/85; B01J 29/76

(52) U.S. Cl. CPC F01N 3/2066; F01N 3/0842; F01N 3/0814; F01N 3/106; F01N 3/035; F01N 13/0093; B01D 2255/20761; B01D 53/944; B01J 29/85; B01J 29/763; F01N 2610/02; F01N 2610/1453; F01N 2370/04; B01D 53/9418

(57) ABSTRACT

Systems and methods related to an exhaust gas purification system comprising: an injector for injecting ammonia or a compound decomposable to ammonia into the exhaust gas, positioned downstream of an engine; a Cu-SCR catalyst positioned downstream of the injector, wherein no oxidation catalysts exist between the Cu-SCR catalyst and the engine; wherein the exhaust gas entering the Cu-SCR catalyst comprises an NH₃/NOx ratio of less than 1.2.

### BACKGROUND

Diesel engines produce an exhaust emission that generally contains at least four classes of pollutant that are legislated against by inter-governmental organisations throughout the world: carbon monoxide (CO), unburned hydrocarbons (HCs), oxides of nitrogen (NOₓ) and particulate matter (PM). A variety of emissions control devices exist for treating one or more of each type of pollutant. These emissions control devices are often combined as part of an exhaust system to ensure that all four classes of pollutant are treated before emission of the exhaust gas into the environment.

Diesel engines are being designed to have improved fuel economy. As a consequence of these designs, the diesel engines output higher levels of oxides of nitrogen (NOₓ) and the exhaust systems for such engines are required to provide increasingly higher NOₓ conversion to meet emission regulations.

Selective catalytic reduction (SCR) has been demonstrated to be an effective solution for meeting NOₓ emission requirements and regulations for diesel engines. SCR catalysts often include copper; such Cu-SCR catalysts may provide desirable NOx conversion, but have drawbacks such as deactivation by sulfur fuel.

### SUMMARY OF THE INVENTION

According to some embodiments of the present invention, an exhaust gas purification system includes an injector for injecting ammonia or a compound decomposable to ammonia into the exhaust gas, positioned downstream of an engine; a Cu-SCR catalyst positioned downstream of the injector, wherein no oxidation catalysts exist between the Cu-SCR catalyst and the engine; wherein the exhaust gas entering the Cu-SCR catalyst comprises an NH₃/NOx ratio of less than 1.2. The system may further include a downstream system comprising one or more of a reductant injector, an SCR catalyst, an SCRF catalyst, a lean NOx trap, an ASC, a filter, an oxidation catalyst, SCRT and combinations thereof. For example, the downstream system may include two or more SCR catalysts. In some embodiments, the system may include an additional SCR catalyst upstream of the Cu-SCR catalyst. The Cu-SCR catalyst may comprise Cu exchanged SAPO34, Cu exchanged CHA zeolites, Cu exchanged AEI zeolites, or combinations thereof. In some embodiments, the exhaust gas entering the Cu-SCR catalyst may have an NH₃/NOx ratio of about 0.4 to about 0.9.

According to some embodiments of the present invention, an exhaust gas purification system includes an injector for injecting ammonia or a compound decomposable to ammonia into the exhaust gas, positioned downstream of an engine; a Cu-SCR catalyst positioned downstream of the urea/ammonia injector, wherein no oxidation catalysts exist between the Cu-SCR catalyst and the engine; wherein the Cu-SCR catalyst comprises Cu exchanged SAPO-34, Cu exchanged CHA zeolite, Cu exchanged AEI zeolites, or combinations thereof. The system may further include a downstream system comprising one or more of a reductant injector, an SCR catalyst, an SCRF catalyst, a lean NOx trap, an ASC, a filter, an oxidation catalyst, SCRT and combinations thereof. For example, the downstream system may include two or more SCR catalysts. In some embodiments, the system may include an additional SCR catalyst upstream of the Cu-SCR catalyst. The Cu-SCR catalyst may comprise Cu exchanged SAPO34, Cu exchanged CHA zeolites, Cu exchanged AEI zeolites, or combinations thereof. In some embodiments, the exhaust gas entering the Cu-SCR catalyst may have an NH₃/NOx ratio of less than 1.2, less than 1, about 0.4 to about 1, or about 0.4 to about 0.9.

According to some embodiments of the present invention, a method of purifying exhaust gas includes adding ammonia or a compound decomposable into ammonia into the exhaust gas by an injector located downstream of an engine; passing the exhaust gas through a Cu-SCR catalyst, wherein the Cu-SCR catalyst is positioned downstream of the injector and no oxidation catalysts exist between the Cu-SCR catalyst and the engine; and wherein the amount of ammonia or of a compound decomposable to ammonia added to the exhaust gas stream is selected so that the exhaust gas entering the Cu-SCR catalyst has an NH₃/NOx ratio of less than 1.2. In some embodiments, the amount of ammonia or of a compound decomposable to ammonia added to the exhaust gas stream is selected so that the exhaust gas entering the Cu-SCR catalyst has an NH₃/NOx ratio of about 0.4 to about 0.9. The Cu-SCR catalyst may comprise Cu exchanged SAPO34, Cu exchanged CHA zeolite, Cu exchanged AEI zeolites, or combinations thereof. The rate of sulfation of the Cu-SCR catalyst may be lower than the rate of sulfation of a Cu-SCR catalyst in an equivalent system except for comprising an oxidation catalyst upstream of the Cu-SCR catalyst. The NOx conversion of the Cu-SCR catalyst may be higher than the NOx conversion of a Cu-SCR catalyst in an equivalent system except for comprising an oxidation catalyst upstream of the Cu-SCR catalyst. Similarly, the rate of sulfation of the Cu-SCR catalyst may be lower than the rate of sulfation of a Cu-SCR catalyst in an equivalent system except for having an exhaust gas entering the Cu-SCR catalyst that has an NH3/NOx ratio of 1.2 or greater. The NOx conversion of the Cu-SCR catalyst may be higher than the NOx conversion of a Cu-SCR catalyst in an equivalent system except for having an exhaust gas entering the Cu-SCR catalyst that has an NH₃/NOx ratio of 1.2 or greater. In some embodiments, the method further comprises passing the exhaust gas through an additional SCR catalyst upstream of the Cu-SCR catalyst and/or through a downstream system comprising one or more of a reductant injector, an SCR catalyst, an SCRF catalyst, a lean NOx trap, an ASC, a filter, an oxidation catalyst, SCRT and combinations thereof. The downstream system may have, for example, two or more SCR catalysts.

According to some embodiments of the present invention, a method of purifying exhaust gas includes adding ammonia or a compound decomposable into ammonia into the exhaust gas by an injector located downstream of an engine; passing the exhaust gas through a Cu-SCR catalyst, wherein the Cu-SCR catalyst is positioned downstream of the injector and no oxidation catalysts exist between the Cu-SCR catalyst and the engine; and wherein the Cu-SCR catalyst comprises Cu exchanged SAPO34, Cu exchanged CHA zeolite, Cu exchanged AEI zeolites, or combinations thereof. In some embodiments, the amount of ammonia or of a compound decomposable to ammonia added to the exhaust gas stream is selected so that the exhaust gas entering the Cu-SCR catalyst has an NH₃/NOx ratio of less than 1.2, less than 1, about 0.4 to about 1, or about 0.4 to about 0.9. The rate of sulfation of the Cu-SCR catalyst may be lower than the rate of sulfation of a Cu-SCR catalyst in an equivalent system except for comprising an oxidation catalyst upstream of the Cu-SCR catalyst. The NOx conversion of the Cu-SCR catalyst may be higher than the NOx conversion of a Cu-SCR catalyst in an equivalent system except for comprising an oxidation catalyst upstream of the Cu-SCR catalyst. Similarly, the rate of sulfation of the Cu-SCR catalyst may be lower than the rate of sulfation of a Cu-SCR catalyst in an equivalent system except for having an exhaust gas entering the Cu-SCR catalyst that has an NH3/NOx ratio of 1.2 or greater. The NOx conversion of the Cu-SCR catalyst may be higher than the NOx conversion of a Cu-SCR catalyst in an equivalent system except for having an exhaust gas entering the Cu-SCR catalyst that has an NH₃/NOx ratio of 1.2 or greater. In some embodiments, the method further comprises passing the exhaust gas through an additional SCR catalyst upstream of the Cu-SCR catalyst and/or through a downstream system comprising one or more of a reductant injector, an SCR catalyst, an SCRF catalyst, a lean NOx trap, an ASC, a filter, an oxidation catalyst, SCRT and combinations thereof. The downstream system may have, for example, two or more SCR catalysts.

### BRIEF DESCRIPTION OF THE DRAWINGS

FIG. 1 shows an exhaust system including injector 20 for injecting ammonia or a compound decomposable to ammonia into the exhaust gas, positioned downstream from engine 10. SCR catalyst 30 is located downstream of injector 20. The system also includes downstream system 40, positioned downstream from SCR catalyst 30.

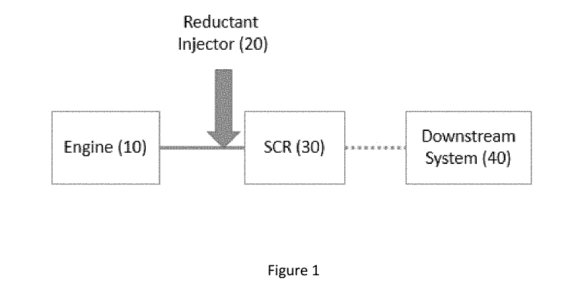

FIG. 2 shows the effect of sulfation without an upstream oxidation catalyst, and with an ANR of 1.1.

FIG. 3 shows the effect of sulfation without an upstream oxidation catalyst, and with the sulfation step completed at ANR 0.5 and the desulfation steps completed at ANR 1.1.

### DETAILED DESCRIPTION

Systems and methods of the present invention relate to purification of an exhaust gas from an internal combustion engine. The invention is particularly directed to cleaning of an exhaust gas from a diesel engine.

It has been found that effects of sulfation on a selective catalytic reduction (“SCR) catalyst may be substantially lessened based on the position of the SCR catalyst relative to other components within an exhaust system, and/or based on the NH₃:NOₓ ratio of the exhaust gas entering the SCR catalyst. Specifically, it has been discovered that positioning an SCR catalyst such that no oxidation catalysts exist between the SCR catalyst and the engine may provide benefits in terms of the impact of sulfur on the SCR catalyst. Systems and methods of the present invention may include any type of SCR catalyst, however, SCR catalysts including copper (“Cu-SCR catalysts”) may experience more notable benefits from such an arrangement, as they are particularly vulnerable to the effects of sulfation. Cu-SCR catalysts may include, for example, Cu exchanged SAPO-34, Cu exchanged CHA zeolite, Cu exchanged AEI zeolites, or combinations thereof. Further, it has surprisingly been found that a low NH₃:NOₓ ratio dosing strategy may provide further reduction in the effects of sulfation on the SCR catalyst in embodiments of the present invention. Specifically, particular benefits may be realized when the exhaust gas entering the SCR catalyst has an NH₃/NOₓ ratio of less than 1.2.

Introduction of Reductant

Systems of the present invention may include one or more means for introducing a nitrogenous reductant into the exhaust system upstream of the SCR catalyst. The reductant is added to the flowing exhaust gas by any suitable means for introducing a reductant into the exhaust gas. Suitable means include an injector, sprayer, doser, or feeder. Such means are well known in the art. As used herein, the term injector is understood to encompass means of introducing a nitrogenous reductant such as a sprayer, doser, or feeder. Preferably, the exhaust system includes an injector for introducing ammonia or a compound decomposable to ammonia into the exhaust gas.

The nitrogenous reductant for use in the system can be ammonia per se, hydrazine, or a compound decomposable into ammonia such as urea, ammonium carbonate, ammonium carbamate, ammonium hydrogen carbonate, and ammonium formate, preferably urea.

The injector may be positioned downstream of an engine, and upstream of the SCR catalyst. The injector may be positioned directly upstream of the SCR catalyst (e.g. there is no intervening catalyst between the injector and the SCR catalyst). Preferably, no oxidation catalysts are present between the engine and the injector. Preferably, no oxidation catalysts are present between the injector and the SCR catalyst.

The exhaust system may also comprise a means for controlling the introduction of reductant into the exhaust gas in order to reduce NOx therein. Suitable control means may include an electronic control unit, optionally an engine control unit, and may additionally comprise one or more NOx sensors located upstream of the reductant introduction and/or SCR catalyst, and/or downstream of the SCR catalyst. Suitably placed temperature sensors may also be utilized. In some embodiments, a reductant such as urea is injected at temperatures greater than 180° C. The rate of injection may be dependent on the speed and/or load of the engine.

In some embodiments, the amount of ammonia or compound decomposable to ammonia which is added to the gas stream is selected so that the exhaust gas stream entering the SCR catalyst has an NH₃:NOx ratio of less than 1.2; less than 1.1; less than 1; about 0.1 to about 1.1; about 0.5 to about 1.1; about 0.4 to about 1.1; about 0.3 to about 1.1; about 0.5 to about 1; about 0.4 to about 1; about 0.3 to about 1; about 0.2 to about 1; about 0.1 to about 0.9; about 0.5 to about 0.9; about 0.4 to about 0.9; about 0.3 to about 0.9; about 0.5 to about 0.8; about 0.4 to about 0.8; about 0.3 to about 0.8; about 0.1 to about 0.8; about 0.1 to about 0.7; about 0.1 to about 0.6; about 0.1 to about 0.5; about 0.2 to about 0.9; about 0.2 to about 0.8; about 0.2 to about 0.7; about 0.2 to about 0.6; or about 0.2 to about 0.5. As used to herein, the NH₃:NOx ratio refers to a molar ratio. Such ammonia dosing reduce sulfation on the SCR catalyst and/or may prevent NH₃ from slipping over downstream oxidation catalysts creating NOx.

One or more secondary reductant injectors may be included as desired.

The exhaust system may further comprise a mixer, wherein the mixer is (e.g. located, such as in the exhaust gas conduit), for example, upstream of the SCR catalyst and downstream of the injector.

SCR Catalyst

Systems of the present invention may include one or more SCR catalyst. The system includes an SCR catalyst positioned downstream of the injector. Systems of the present invention may also include one or more additional SCR catalysts in a downstream system; the downstream system will be described in further detail in a later section.

The exhaust system of the invention comprises an SCR catalyst which is positioned downstream of the injector for introducing ammonia or a compound decomposable to ammonia into the exhaust gas. The SCR catalyst may be positioned directly downstream of the injector for injecting ammonia or a compound decomposable to ammonia (e.g. there is no intervening catalyst between the injector and the SCR catalyst). Preferably, no oxidation catalysts are present between the engine and the SCR catalyst.

The SCR catalyst includes a substrate and a catalyst composition. The substrate may be a flow-through substrate or a filtering substrate. When the SCR catalyst has a flow-through substrate, then the substrate may comprise the SCR catalyst composition (i.e. the SCR catalyst is obtained by extrusion) or the SCR catalyst composition may be disposed or supported on the substrate (i.e. the SCR catalyst composition is applied onto the substrate by a washcoating method).

When the SCR catalyst has a filtering substrate, then it is a selective catalytic reduction filter catalyst, which is referred to herein by the abbreviation “SCRF”. The SCRF comprises a filtering substrate and the selective catalytic reduction (SCR) composition. References to use of SCR catalysts throughout this application are understood to include use of SCRF catalysts as well, where applicable.

The selective catalytic reduction composition may comprise, or consist essentially of, a metal oxide based SCR catalyst formulation, a molecular sieve based SCR catalyst formulation, or mixture thereof. Such SCR catalyst formulations are known in the art.

The selective catalytic reduction composition may comprise, or consist essentially of, a metal oxide based SCR catalyst formulation. The metal oxide based SCR catalyst formulation comprises vanadium or tungsten or a mixture thereof supported on a refractory oxide. The refractory oxide may be selected from the group consisting of alumina, silica, titania, zirconia, ceria and combinations thereof.

The metal oxide based SCR catalyst formulation may comprise, or consist essentially of, an oxide of vanadium (e.g. V₂O₅) and/or an oxide of tungsten (e.g. WO₃) supported on a refractory oxide selected from the group consisting of titania (e.g. TiO₂), ceria (e.g. CeO₂), and a mixed or composite oxide of cerium and zirconium (e.g. CeₓZn₍₁₋ₓ₎O₂, wherein x=0.1 to 0.9, preferably x=0.2 to 0.5).

When the refractory oxide is titania (e.g. TiO₂), then preferably the concentration of the oxide of vanadium is from 0.5 to 6 wt. % (e.g. of the metal oxide based SCR formulation) and/or the concentration of the oxide of tungsten (e.g. WO₃) is from 5 to 20 wt. %. More preferably, the oxide of vanadium (e.g. V₂O₅) and the oxide of tungsten (e.g. WO₃) are supported on titania (e.g. TiO₂).

When the refractory oxide is ceria (e.g. CeO₂), then preferably the concentration of the oxide of vanadium is from 0.1 to 9 wt. % (e.g. of the metal oxide based SCR formulation) and/or the concentration of the oxide of tungsten (e.g. WO₃) is from 0.1 to 9 wt. %.

The metal oxide based SCR catalyst formulation may comprise, or consist essentially of, an oxide of vanadium (e.g. V₂O₅) and optionally an oxide of tungsten (e.g. WO₃), supported on titania (e.g. TiO₂).

The selective catalytic reduction composition may comprise, or consist essentially of, a molecular sieve based SCR catalyst formulation. The molecular sieve based SCR catalyst formulation comprises a molecular sieve, which is optionally a transition metal exchanged molecular sieve. It is preferable that the SCR catalyst formulation comprises a transition metal exchanged molecular sieve. In general, the molecular sieve based SCR catalyst formulation may comprise a molecular sieve having an aluminosilicate framework (e.g. zeolite), an aluminophosphate framework (e.g. AlPO), a silicoaluminophosphate framework (e.g. SAPO), a heteroatom-containing aluminosilicate framework, a heteroatom-containing aluminophosphate framework (e.g. MeAlPO, where Me is a metal), or a heteroatom-containing silicoaluminophosphate framework (e.g. MeAPSO, where Me is a metal). The heteroatom (i.e. in a heteroatom-containing framework) may be selected from the group consisting of boron (B), gallium (Ga), titanium (Ti), zirconium (Zr), zinc (Zn), iron (Fe), vanadium (V) and combinations of any two or more thereof. It is preferred that the heteroatom is a metal (e.g. each of the above heteroatom-containing frameworks may be a metal-containing framework).

It is preferable that the molecular sieve based SCR catalyst formulation comprises, or consist essentially of, a molecular sieve having an aluminosilicate framework (e.g. zeolite) or a silicoaluminophosphate framework (e.g. SAPO).

When the molecular sieve has an aluminosilicate framework (e.g. the molecular sieve is a zeolite), then typically the molecular sieve has a silica to alumina molar ratio (SAR) of from 5 to 200 (e.g. 10 to 200), preferably 10 to 100 (e.g. 10 to 30 or 20 to 80), such as 12 to 40, more preferably 15 to 30. Typically, the molecular sieve is microporous. A microporous molecular sieve has pores with a diameter of less than 2 nm (e.g. in accordance with the IUPAC definition of “microporous” [see Pure & Appl. Chem., 66(8), (1994), 1739-1758)]).

The molecular sieve based SCR catalyst formulation may comprise a small pore molecular sieve (e.g. a molecular sieve having a maximum ring size of eight tetrahedral atoms), a medium pore molecular sieve (e.g. a molecular sieve having a maximum ring size of ten tetrahedral atoms) or a large pore molecular sieve (e.g. a molecular sieve having a maximum ring size of twelve tetrahedral atoms) or a combination of two or more thereof.

When the molecular sieve is a small pore molecular sieve, then the small pore molecular sieve may have a framework structure represented by a Framework Type Code (FTC) selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG and ZON, or a mixture and/or an intergrowth of two or more thereof. Preferably, the small pore molecular sieve has a framework structure represented by a FTC selected from the group consisting of CHA, LEV, AEI, AFX, ERI, SFW, KFI, DDR and ITE. More preferably, the small pore molecular sieve has a framework structure represented by a FTC selected from the group consisting of CHA and AEI. The small pore molecular sieve may have a framework structure represented by the FTC CHA. The small pore molecular sieve may have a framework structure represented by the FTC AEI. When the small pore molecular sieve is a zeolite and has a framework represented by the FTC CHA, then the zeolite may be chabazite.

When the molecular sieve is a medium pore molecular sieve, then the medium pore molecular sieve may have a framework structure represented by a Framework Type Code (FTC) selected from the group consisting of AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, -PAR, PCR, PON, PUN, RRO, RSN, SFF, SFG, STF, STI, STT, STW, -SVR, SZR, TER, TON, TUN, UOS, VSV, WEI and WEN, or a mixture and/or an intergrowth of two or more thereof. Preferably, the medium pore molecular sieve has a framework structure represented by a FTC selected from the group consisting of FER, MEL, MFI, and STT. More preferably, the medium pore molecular sieve has a framework structure represented by a FTC selected from the group consisting of FER and MFI, particularly MFI. When the medium pore molecular sieve is a zeolite and has a framework represented by the FTC FER or MFI, then the zeolite may be ferrierite, silicalite or ZSM-5.

When the molecular sieve is a large pore molecular sieve, then the large pore molecular sieve may have a framework structure represented by a Framework Type Code (FTC) selected from the group consisting of AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTE, LTL, MAZ, MEI, MOR, MOZ, MSE, MTW, NPO, OFF, OKO, OSI, -RON, RWY, SAF, SAO, SBE, SBS, SBT, SEW, SFE, SFO, SFS, SFV, SOF, SOS, STO, SSF, SSY, USI, UWY, and VET, or a mixture and/or an intergrowth of two or more thereof. Preferably, the large pore molecular sieve has a framework structure represented by a FTC selected from the group consisting of AFI, BEA, MAZ, MOR, and OFF. More preferably, the large pore molecular sieve has a framework structure represented by a FTC selected from the group consisting of BEA, MOR and MFI. When the large pore molecular sieve is a zeolite and has a framework represented by the FTC BEA, FAU or MOR, then the zeolite may be a beta zeolite, faujasite, zeolite Y, zeolite X or mordenite.

In general, it is preferred that the molecular sieve is a small pore molecular sieve.

The molecular sieve based SCR catalyst formulation preferably comprises a transition metal exchanged molecular sieve. The transition metal may be selected from the group consisting of cobalt, copper, iron, manganese, nickel, palladium, platinum, ruthenium and rhenium.

The transition metal may be copper. An advantage of SCR catalyst formulations containing a copper exchanged molecular sieve is that such formulations have excellent low temperature NOₓ reduction activity (e.g. it may be superior to the low temperature NOₓ reduction activity of an iron exchanged molecular sieve). Systems and method of the present invention may include any type of SCR catalyst, however, SCR catalysts including copper (“Cu-SCR catalysts”) may experience more notable benefits from systems of the present invention, as they are particularly vulnerable to the effects of sulfation. Cu-SCR catalyst formulations may include, for example, Cu exchanged SAPO-34, Cu exchanged CHA zeolite, Cu exchanged AEI zeolites, or combinations thereof.

The transition metal may be present on an extra-framework site on the external surface of the molecular sieve or within a channel, cavity or cage of the molecular sieve.

Typically, the transition metal exchanged molecular sieve comprises an amount of 0.10 to 10% by weight of the transition metal exchanged molecular, preferably an amount of 0.2 to 5% by weight.

In general, the selective catalytic reduction catalyst comprises the selective catalytic reduction composition in a total concentration of 0.5 to 4.0 g in⁻³, preferably 1.0 to 3.0 4.0 g in⁻³.

The SCR catalyst composition may comprise a mixture of a metal oxide based SCR catalyst formulation and a molecular sieve based SCR catalyst formulation. The (a) metal oxide based SCR catalyst formulation may comprise, or consist essentially of, an oxide of vanadium (e.g. V₂O₅) and optionally an oxide of tungsten (e.g. WO₃), supported on titania (e.g. TiO₂) and (b) the molecular sieve based SCR catalyst formulation may comprise a transition metal exchanged molecular sieve.

When the SCR catalyst is an SCRF, then the filtering substrate may preferably be a wall flow filter substrate monolith, such as described herein in relation to a catalysed soot filter. The wall flow filter substrate monolith (e.g. of the SCR-DPF) typically has a cell density of 60 to 400 cells per square inch (cpsi). It is preferred that the wall flow filter substrate monolith has a cell density of 100 to 350 cpsi, more preferably 200 to 300 cpsi.

The wall flow filter substrate monolith may have a wall thickness (e.g. average internal wall thickness) of 0.20 to 0.50 mm, preferably 0.25 to 0.35 mm (e.g. about 0.30 mm).

Generally, the uncoated wall flow filter substrate monolith has a porosity of from 50 to 80%, preferably 55 to 75%, and more preferably 60 to 70%.

The uncoated wall flow filter substrate monolith typically has a mean pore size of at least 5 μm. It is preferred that the mean pore size is from 10 to 40 μm, such as 15 to 35 μm, more preferably 20 to 30 μm.

The wall flow filter substrate may have a symmetric cell design or an asymmetric cell design.

In general for an SCRF, the selective catalytic reduction composition is disposed within the wall of the wall-flow filter substrate monolith. Additionally, the selective catalytic reduction composition may be disposed on the walls of the inlet channels and/or on the walls of the outlet channels.

Diesel Oxidation Catalyst

Systems of the present invention may include one or more diesel oxidation catalysts. Oxidation catalysts, and in particular diesel oxidation catalysts (DOCS), are well-known in the art. Oxidation catalysts are designed to oxidize CO to CO₂ and gas phase hydrocarbons (HC) and an organic fraction of diesel particulates (soluble organic fraction) to CO₂ and H₂O. Typical oxidation catalysts include platinum and optionally also palladium on a high surface area inorganic oxide support, such as alumina, silica-alumina and a zeolite.

NOx Storage Catalyst

Systems of the present invention may include one or more NOx storage catalysts. NOx storage catalysts may include devices that adsorb, release, and/or reduce NOx according to certain conditions, generally dependent on temperature and/or rich/lean exhaust conditions. NOx storage catalysts may include, for example, passive NOx adsorbers, cold start catalysts, NOx traps, and the like.

Passive NOx Adsorber

Systems of the present invention may include one or more passive NOx adsorbers. A passive NOₓ adsorber is a device that is effective to adsorb NOₓ at or below a low temperature and release the adsorbed NOₓ at temperatures above the low temperature. A passive NOₓ adsorber may comprise a noble metal and a small pore molecular sieve. The noble metal is preferably palladium, platinum, rhodium, gold, silver, iridium, ruthenium, osmium, or mixtures thereof. Preferably, the low temperature is about 200° C., about 250° C., or between about 200° C. to about 250° C. An example of a suitable passive NOx adsorber is described in U.S. Patent Publication No. 20150158019, which is incorporated by reference herein in its entirety.

The small pore molecular sieve may be any natural or a synthetic molecular sieve, including zeolites, and is preferably composed of aluminum, silicon, and/or phosphorus. The molecular sieves typically have a three-dimensional arrangement of SiO₄, AlO₄, and/or PO₄ that are joined by the sharing of oxygen atoms, but may also be two-dimensional structures as well. The molecular sieve frameworks are typically anionic, which are counterbalanced by charge compensating cations, typically alkali and alkaline earth elements (e.g., Na, K, Mg, Ca, Sr, and Ba), ammonium ions, and also protons. Other metals (e.g., Fe, Ti, and Ga) may be incorporated into the framework of the small pore molecular sieve to produce a metal-incorporated molecular sieve.

Preferably, the small pore molecular sieve is selected from an aluminosilicate molecular sieve, a metal-substituted aluminosilicate molecular sieve, an aluminophosphate molecular sieve, or a metal-substituted aluminophosphate molecular sieve. More preferably, the small pore molecular sieve is a molecular sieve having the Framework Type of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, and ZON, as well as mixtures or intergrowths of any two or more. Particularly preferred intergrowths of the small pore molecular sieves include KFI-SIV, ITE-RTH, AEW-UEI, AEI-CHA, and AEI-SAV. Most preferably, the small pore molecular sieve is AEI or CHA, or an AEI-CHA intergrowth.

A suitable passive NOₓ adsorber may be prepared by any known means. For instance, the noble metal may be added to the small pore molecular sieve to form the passive NOₓ adsorber by any known means. For example, a noble metal compound (such as palladium nitrate) may be supported on the molecular sieve by impregnation, adsorption, ion-exchange, incipient wetness, precipitation, or the like. Other metals may also be added to the passive NOₓ adsorber. Preferably, some of the noble metal (more than 1 percent of the total noble metal added) in the passive NOₓ adsorber is located inside the pores of the small pore molecular sieve. More preferably, more than 5 percent of the total amount of noble metal is located inside the pores of the small pore molecular sieve; and even more preferably may be greater than 10 percent or greater than 25% or greater than 50 percent of the total amount of noble metal that is located inside the pores of the small pore molecular sieve.

Preferably, the passive NOₓ adsorber further comprises a flow-through substrate or filter substrate. The passive NOₓ adsorber is coated onto the flow-through or filter substrate, and preferably deposited on the flow-through or filter substrate using a washcoat procedure to produce a passive NOₓ adsorber system.

Cold Start Catalyst

Systems of the present invention may include one or more cold start catalysts. A cold start catalyst is a device that is effective to adsorb NOₓ and hydrocarbons (HC) at or below a low temperature and to convert and release the adsorbed NOₓ and HC at temperatures above the low temperature. Preferably, the low temperature is about 200° C., about 250° C., or between about 200° C. to about 250° C. An example of a suitable cold start catalyst is described in WO 2015085300, which is incorporated by reference herein in its entirety.

A cold start catalyst may comprise a molecular sieve catalyst and a supported platinum group metal catalyst. The molecular sieve catalyst may include or consist essentially of a noble metal and a molecular sieve. The supported platinum group metal catalyst comprises one or more platinum group metals and one or more inorganic oxide carriers. The noble metal is preferably palladium, platinum, rhodium, gold, silver, iridium, ruthenium, osmium, or mixtures thereof.

The molecular sieve may be any natural or a synthetic molecular sieve, including zeolites, and is preferably composed of aluminum, silicon, and/or phosphorus. The molecular sieves typically have a three-dimensional arrangement of SiO₄, AlO₄, and/or PO₄ that are joined by the sharing of oxygen atoms, but may also be two-dimensional structures as well. The molecular sieve frameworks are typically anionic, which are counterbalanced by charge compensating cations, typically alkali and alkaline earth elements (e.g., Na, K, Mg, Ca, Sr, and Ba), ammonium ions, and also protons.

The molecular sieve may preferably be a small pore molecular sieve having a maximum ring size of eight tetrahedral atoms, a medium pore molecular sieve having a maximum ring size of ten tetrahedral atoms, or a large pore molecular sieve having a maximum ring size of twelve tetrahedral atoms. More preferably, the molecular sieve has a framework structure of AEI, MFI, EMT, ERI, MOR, FER, BEA, FAU, CHA, LEV, MWW, CON, EUO, or mixtures thereof.

The supported platinum group metal catalyst comprises one or more platinum group metals (“PGM”) and one or more inorganic oxide carriers. The PGM may be platinum, palladium, rhodium, iridium, or combinations thereof, and most preferably platinum and/or palladium. The inorganic oxide carriers most commonly include oxides of Groups 2, 3, 4, 5, 13 and 14 elements. Useful inorganic oxide carriers preferably have surface areas in the range 10 to 700 m²/g, pore volumes in the range 0.1 to 4 mL/g, and pore diameters from about 10 to 1000 Angstroms. The inorganic oxide carrier is preferably alumina, silica, titania, zirconia, ceria, niobia, tantalum oxides, molybdenum oxides, tungsten oxides, or mixed oxides or composite oxides of any two or more thereof, e.g. silica-alumina, ceria-zirconia or alumina-ceria-zirconia. Alumina and ceria are particularly preferred.

The supported platinum group metal catalyst may be prepared by any known means. Preferably, the one or more platinum group metals are loaded onto the one or more inorganic oxides by any known means to form the supported PGM catalyst, the manner of addition is not considered to be particularly critical. For example, a platinum compound (such as platinum nitrate) may be supported on an inorganic oxide by impregnation, adsorption, ion-exchange, incipient wetness, precipitation, or the like. Other metals, such as iron, manganese, cobalt and barium, may also be added to the supported PGM catalyst.

A cold start catalyst of the present invention may be prepared by processes well known in the art. The molecular sieve catalyst and the supported platinum group metal catalyst may be physically mixed to produce the cold start catalyst. Preferably, the cold start catalyst further comprises a flow-through substrate or filter substrate. In one embodiment, the molecular sieve catalyst and the supported platinum group metal catalyst are coated onto the flow-through or filter substrate, and preferably deposited on the flow-through or filter substrate using a washcoat procedure to produce a cold start catalyst system.

NOx Traps

Systems of the present invention may include one or more NOx traps. NOx traps are devices that adsorb NOx under lean exhaust conditions, release the adsorbed NOx under rich conditions, and reduce the released NOx to form N₂.

A NOx trap of embodiments of the present invention may include a NOx adsorbent for the storage of NOx and an oxidation/reduction catalyst. Typically, nitric oxide reacts with oxygen to produce NO₂ in the presence of the oxidation catalyst. Second, the NO₂ is adsorbed by the NOx adsorbent in the form of an inorganic nitrate (for example, BaO or BaCO₃ is converted to Ba(NO₃)₂ on the NOx adsorbent). Lastly, when the engine runs under rich conditions, the stored inorganic nitrates decompose to form NO or NO₂ which are then reduced to form N₂ by reaction with carbon monoxide, hydrogen, and/or hydrocarbons (or via NHₓ or NCO intermediates) in the presence of the reduction catalyst. Typically, the nitrogen oxides are converted to nitrogen, carbon dioxide, and water in the presence of heat, carbon monoxide, and hydrocarbons in the exhaust stream.

The NOx adsorbent component is preferably an alkaline earth metal (such as Ba, Ca, Sr, and Mg), an alkali metal (such as K, Na, Li, and Cs), a rare earth metal (such as La, Y, Pr, and Nd), or combinations thereof. These metals are typically found in the form of oxides. The oxidation/reduction catalyst may include one or more noble metals. Suitable noble metals may include platinum, palladium, and/or rhodium. Preferably, platinum is included to perform the oxidation function and rhodium is included to perform the reduction function. The oxidation/reduction catalyst and the NOx adsorbent may be loaded on a support material such as an inorganic oxide for use in the exhaust system.

Ammonia Oxidation Catalyst

Systems of the present invention may include one or more ammonia oxidation catalysts, also called an ammonia slip catalyst (“ASC”). One or more ASC may be included downstream from an SCR catalyst, to oxidize excess ammonia and prevent it from being released to the atmosphere. In some embodiments the ASC may be included on the same substrate as an SCR catalyst. In certain embodiments, the ammonia oxidation catalyst material may be selected to favor the oxidation of ammonia instead of the formation of NOₓ or N₂O. Preferred catalyst materials include platinum, palladium, or a combination thereof, with platinum or a platinum/palladium combination being preferred. Preferably, the ammonia oxidation catalyst comprises platinum and/or palladium supported on a metal oxide. Preferably, the catalyst is disposed on a high surface area support, including but not limited to alumina.

Three-Way Catalysts

Systems of the present invention may include one or more three-way catalysts (TWCs). TWCs are typically used in gasoline engines under stoichiometric conditions in order to convert NOₓ to N₂, carbon monoxide to CO₂, and hydrocarbons to CO₂ and H₂O on a single device.

Filters

Systems of the present invention may include one or more particulate filters. Particulate filters are devices that reduce particulates from the exhaust of internal combustion engines. Particulate filters include catalyzed particulate filters and bare (non-catalyzed) particulate filters. Catalyzed particulate filters, also called catalyzed soot filters, (for diesel and gasoline applications) include metal and metal oxide components (such as Pt, Pd, Fe, Mn, Cu, and ceria) to oxidize hydrocarbons and carbon monoxide in addition to destroying soot trapped by the filter.

Substrate

Catalysts and adsorbers of the present invention may each further comprise a flow-through substrate or filter substrate. In one embodiment, the catalyst/adsorber may be coated onto the flow-through or filter substrate, and preferably deposited on the flow-through or filter substrate using a washcoat procedure.

The combination of an SCR catalyst and a filter is known as a selective catalytic reduction filter (SCRF catalyst). An SCRF catalyst is a single-substrate device that combines the functionality of an SCR and particulate filter, and is suitable for embodiments of the present invention as desired. Description of and references to the SCR catalyst throughout this application are understood to include the SCRF catalyst as well, where applicable.

The flow-through or filter substrate is a substrate that is capable of containing catalyst/adsorber components. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates, metallo aluminosilicates (such as cordierite and spudomene), or a mixture or mixed oxide of any two or more thereof. Cordierite, a magnesium aluminosilicate, and silicon carbide are particularly preferred.

The metallic substrates may be made of any suitable metal, and in particular heat-resistant metals and metal alloys such as titanium and stainless steel as well as ferritic alloys containing iron, nickel, chromium, and/or aluminum in addition to other trace metals.

The flow-through substrate is preferably a flow-through monolith having a honeycomb structure with many small, parallel thin-walled channels running axially through the substrate and extending throughout from an inlet or an outlet of the substrate. The channel cross-section of the substrate may be any shape, but is preferably square, sinusoidal, triangular, rectangular, hexagonal, trapezoidal, circular, or oval. The flow-through substrate may also be high porosity which allows the catalyst to penetrate into the substrate walls.

The filter substrate is preferably a wall-flow monolith filter. The channels of a wall-flow filter are alternately blocked, which allow the exhaust gas stream to enter a channel from the inlet, then flow through the channel walls, and exit the filter from a different channel leading to the outlet. Particulates in the exhaust gas stream are thus trapped in the filter.

The catalyst/adsorber may be added to the flow-through or filter substrate by any known means, such as a washcoat procedure.

Fuel Injector

Systems of the present invention may include one or more fuel injectors. For example, a system may include a secondary fuel injector upstream of a diesel oxidation catalyst. Any suitable type of fuel injector may be used in systems of the present invention.

Embodiments/Systems

Systems of the present invention include an injector for injecting ammonia or a compound decomposable to ammonia into the exhaust gas, positioned downstream of an engine, and an SCR catalyst positioned downstream of the injector. In one aspect of the invention, the SCR catalyst is a Cu-SCR catalyst. The Cu-SCR catalyst may comprise, for example, Cu exchanged SAPO-34, Cu exchanged CHA zeolite, Cu exchanged AEI zeolites, or combinations thereof. It is understood that within the following description, while the SCR catalyst is referred to as “Cu-SCR catalyst,” the scope of the disclosure encompasses any suitable SCR catalyst.

Preferably, no oxidation catalysts are present between the Cu-SCR catalyst and the engine. The section between the engine and the Cu-SCR catalyst may, however, include other suitable components such as those described in the preceding sections, as desired. The injector may be positioned directly upstream of the Cu-SCR catalyst (e.g. there is no intervening catalyst between the injector and the Cu-SCR catalyst). Alternatively, the system may include an additional SCR catalyst positioned between the injector and the Cu-SCR catalyst. Optionally, a mixer may be included between the injector and the Cu-SCR catalyst.

The injector may be configured to introduce ammonia or a compound decomposable to ammonia into the exhaust gas such that the exhaust gas entering the Cu-SCR catalyst has a low NH₃/NOx ratio. The exhaust system may also comprise one or more means for controlling the introduction of reductant into the exhaust gas, such as an electronic control unit, optionally an engine control unit, and may additionally comprise one or more NOx sensors located upstream of the reductant introduction and/or Cu-SCR catalyst, and/or downstream of the Cu-SCR catalyst. Suitably placed temperature sensors may also be utilized. In some embodiments, a reductant such as urea is injected at temperatures greater than 180° C. The rate of injection may be dependent on the speed and/or load of the engine.

In some aspects of the invention, the injector is configured to introduce ammonia or a compound decomposable to ammonia into the exhaust gas such that the exhaust gas entering the Cu-SCR catalyst has an NH₃/NOₓ ratio of less than 1.2. In some embodiments, the amount of ammonia or compound decomposable to ammonia which is added to the gas stream is selected so that the exhaust gas stream entering the Cu-SCR catalyst has an NH₃:NOx ratio of less than 1.2; less than 1.1; less than 1; about 0.1 to about 1.1; about 0.1 to about 1.0; about 0.3 to about 1.1; about 0.4 to about 1.1; about 0.5 to about 1.1; about 0.3 to about 1; about 0.4 to about 1; about 0.5 to about 1; about 0.1 to about 0.9; about 0.5 to about 0.9; about 0.4 to about 0.9; about 0.3 to about 0.9; about 0.5 to about 0.8; about 0.4 to about 0.8; about 0.3 to about 0.8; about 0.1 to about 0.8; about 0.1 to about 0.7; about 0.1 to about 0.6; about 0.1 to about 0.5; about 0.2 to about 0.9; about 0.2 to about 0.8; about 0.2 to about 0.7; about 0.2 to about 0.6; or about 0.2 to about 0.5. As used to herein, the NH₃:NOx ratio refers to a molar ratio. Such ammonia dosing may reduce sulfation on the Cu-SCR catalyst and/or may prevent NH₃ from slipping over downstream oxidation catalysts creating NOx.

The section of the system located downstream of the Cu-SCR catalyst is referred to herein as the downstream system, and may include one or more of a reductant injector, an SCR catalyst, an SCRF catalyst, a lean NOx trap, an ASC, a filter, an oxidation catalyst, SCRT and combinations thereof. In one aspect of the invention, the downstream system includes two or more SCR catalysts. In one aspect of the invention, the downstream system includes an ASC. In such embodiments, the ASC may be included as a separated brick, or may be included on the same brick as the Cu-SCR catalyst.

### Methods

Methods of the present invention include purifying diesel engine exhaust gases, comprising adding ammonia or a compound decomposable into ammonia into the exhaust gas by an injector located downstream of the engine; passing the exhaust gas through an SCR catalyst, preferably a Cu-SCR catalyst, which is positioned downstream of the injector. Preferably, no oxidation catalysts exist between the Cu-SCR catalyst and the engine. In an aspect of the invention, the Cu-SCR catalyst comprises Cu exchanged SAPO34, Cu exchanged CHA zeolite, Cu exchanged AEI zeolites, or combinations thereof. The amount of ammonia or of a compound decomposable to ammonia added to the exhaust gas stream may be selected so that the exhaust gas entering the Cu-SCR catalyst has a low NH₃/NOx ratio, such as less than 1.2, less than 1, about 0.4 to about 1.1, or about 0.4 to about 0.9.

The exhaust gas may be passed through an additional SCR catalyst upstream of the Cu-SCR catalyst, and/or through a downstream system which may include one or more of a reductant injector, an SCR catalyst, an SCRF catalyst, a lean NOx trap, an ASC, a filter, an oxidation catalyst, SCRT and combinations thereof. In an aspect of the invention, the exhaust gas may be passed through a downstream system with two or more SCR catalysts.

### Benefits

Systems and methods of the present invention may provide benefits related to reduced effects of sulfation on an SCR catalyst, while still providing effective reduction of undesirable emissions. Specifically, effects of sulfation on an SCR catalyst may be substantially lessened based on the position of the SCR catalyst relative to other components within an exhaust system, and/or based on the NH₃:NOₓ ratio of the exhaust gas entering the SCR catalyst. Benefits associated with such reduced sulfation include less deactivation of the SCR catalyst and higher NOx conversion by the SCR catalyst upon exposure to sulfur, even as sulfur exposure increases. Reduced sulfation may result in a reduced rate of NOx conversion decay for the SCR catalyst upon exposure to sulfur.

Configuring a system such that no oxidation catalysts exist between the Cu-SCR catalyst and the engine may provide benefits in terms of the impact of sulfur on the Cu-SCR catalyst. While systems and methods of the present invention may include any type of SCR catalyst, Cu-SCR catalysts may experience more notable benefits from such an arrangement, as they are particularly vulnerable to the effects of sulfation.

It has also surprisingly been found that a low NH₃:NOₓ ratio dosing strategy may provide further reduction in the effects of sulfation on the SCR catalysts. Specifically, particular benefits may be realized when the exhaust gas entering the SCR catalyst has an NH₃/NOₓ ratio of less than 1.2.

Methods and systems of the present invention may be associated with a lower rate of sulfation of the SCR catalyst as compared to the rate of sulfation of an SCR catalyst in a system which is equivalent except for comprising an oxidation catalyst upstream of the SCR catalyst. Methods and systems of the present invention may be associated with a higher NOx conversion by the SCR catalyst upon exposure to sulfur, even as sulfur exposure increases, as compared to the NOx conversion of an SCR catalyst upon exposure to sulfur in a system which is equivalent except for comprising an oxidation catalyst upstream of the SCR catalyst.

Methods and systems of the present invention may be associated with a lower rate of sulfation of the SCR catalyst as compared to the rate of sulfation of an SCR catalyst in a system which is equivalent except for having an exhaust gas entering the SCR catalyst that has an NH₃/NOx ratio of 1.2 or greater. Methods and systems of the present invention may be associated with a higher NOx conversion by the SCR catalyst upon exposure to sulfur as compared to the NOx conversion of an SCR catalyst upon exposure to sulfur in a system which is equivalent except for having an exhaust gas entering the SCR catalyst that has an NH₃/NOx ratio of 1.2 or greater.

In some embodiments of the present invention, NOx conversion of an SCR catalyst upon exposure to sulfur may be higher than the NOx conversion of an SCR catalyst upon exposure to sulfur in a system which is equivalent except for comprising an oxidation catalyst upstream of the SCR catalyst, by as much as up to 300%; up to 280%; up to 260%; up to 240%; up to 220%; up to 200%; up to 180%; up to 160%; up to 140%; up to 120%; up to 100%; up to 80%; up to 60%; up to 40%; up to 20%; about 20% to about 300%; about 40% to about 280%; about 60% to about 260%; about 80% to about 240%; or about 100% to about 220%.

### Definitions

The term “mixed oxide” as used herein generally refers to a mixture of oxides in a single phase, as is conventionally known in the art. The term “composite oxide” as used herein generally refers to a composition of oxides having more than one phase, as is conventionally known in the art.

For the avoidance of doubt, the term “combination of platinum (Pt) and palladium (Pd)” as used herein in relation to a region, zone or layer refers to the presence of both platinum and palladium. The word “combination” does not require that the platinum and palladium are present as a mixture or an alloy, although such a mixture or alloy is embraced by this term.

The expression “consist essentially” as used herein limits the scope of a feature to include the specified materials, and any other materials or steps that do not materially affect the basic characteristics of that feature, such as for example minor impurities. The expression “consist essentially of” embraces the expression “consisting of”.

The expression “about” as used herein with reference to an end point of a numerical range includes the exact end point of the specified numerical range. Thus, for example, an expression defining a parameter as being up to “about 0.2” includes the parameter being up to and including 0.2.

### EXAMPLES

### Example 1

NOx conversion was measured in various systems to show the effect of sulfation on different SCR catalysts with and without an upstream oxidation catalyst. The following systems were tested:

System 1: Cu-SAPO34 SCR catalyst, without an upstream oxidation catalyst

System 2: Cu-SAPO34 SCR catalyst, with an upstream DOC

System 3: Cu-CHA SCR catalyst, without an upstream oxidation catalyst

System 4: Cu-CHA SCR catalyst, with an upstream DOC

The Cu-CHA SCR catalysts were prepared with 3.3 wt % Cu on CHA-zeolite with SAR 22, on 10.5×6″ with 300/5 cpsi. The loadings were 3.3% Cu spray dried onto 2 g/in³ SAR22 CHA (giving a CuZ loading of 2.09 g/in³). 0.3 g/in³ of boehmite alumina was also added to the washcoat so the total washcoat loading was 2.39 g/in³.

The Cu-SAPO-34 SCR catalysts were prepared with 2.76 wt % Cu on SAPO-34 zeolite, on 10.5×6″ with 300/5 cpsi. The loadings were 2.76% Cu spray dried onto 2 g/in³ SAPO-34 (giving a CuZ loading of 2.07 g/in³). 0.35 g/in³ of boehmite alumina was also added to the washcoat so the total washcoat loading was 2.42 g/in³.

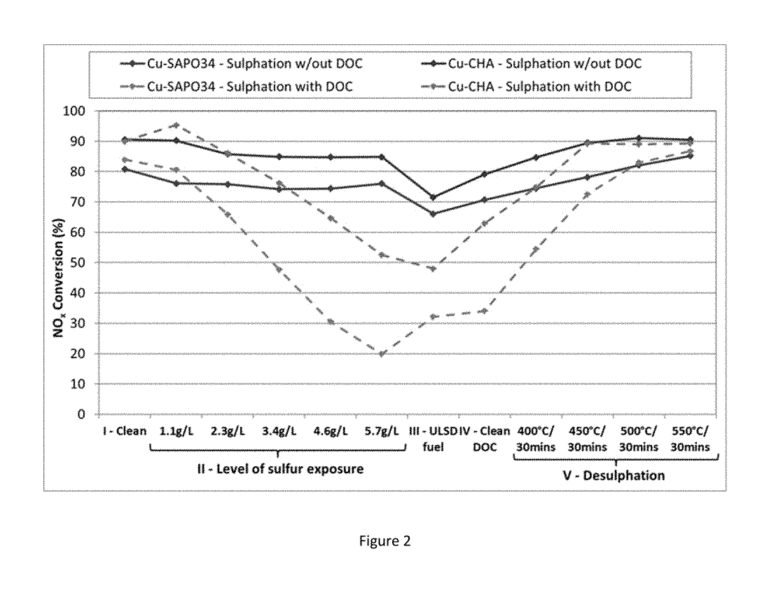

The test results are shown in FIG. 2. NOx conversion of the SCR catalysts was measured using ETC cycles, and with an ANR of 1.1. Sulfur exposure is quantified on the x-axis. Sulfation was completed using 25 consecutive ETC test cycles with LSD fuel, which corresponds to the sulfur exposures included on the graph in FIG. 2. For the desulfation steps, the catalysts were heated to 400° C. for 30 mins, then an ETC cycle was performed and the result of these cycles is shown. The average ETC temperature was 295° C.

As shown in the results plotted in FIG. 2, both catalysts exhibit significantly less deactivation (as represented by higher NOx conversion) as sulfur exposure increases, when there is not a DOC upstream of the Cu-SCR. Such results indicate that the systems without an oxidation catalyst upstream of the Cu-SCR exhibit excellent sulfur tolerance relative to the systems with an oxidation catalyst upstream of the Cu-SCR.

### Example 2

NOx conversion was measured in various systems to show the effect of sulfation on different SCR catalysts with and without an upstream oxidation catalyst. The following systems were tested:

System 1: Cu-SAPO34 SCR catalyst, without an upstream oxidation catalyst

System 2: Cu-SAPO34 SCR catalyst, with an upstream DOC

System 3: Cu-CHA SCR catalyst, without an upstream oxidation catalyst

System 4: Cu-CHA SCR catalyst, with an upstream DOC

The Cu-CHA SCR catalysts were prepared with 3.3 wt % Cu on CHA-zeolite with SAR 22, on 10.5×6″ with 300/5 cpsi. The loadings were 3.3% Cu spray dried onto 2 g/in³ SAR22 CHA (giving a CuZ loading of 2.09 g/in³). 0.3 g/in³ of boehmite alumina was also added to the washcoat so the total washcoat loading was 2.39 g/in³.

The Cu-SAPO-34 SCR catalysts were prepared with 2.76 wt % Cu on SAPO-34 zeolite, on 10.5×6″ with 300/5 cpsi. The loadings were 2.76% Cu spray dried onto 2 g/in³ SAPO-34 (giving a CuZ loading of 2.07 g/in³). 0.35 g/in³ of boehmite alumina was also added to the washcoat so the total washcoat loading was 2.42 g/in³.

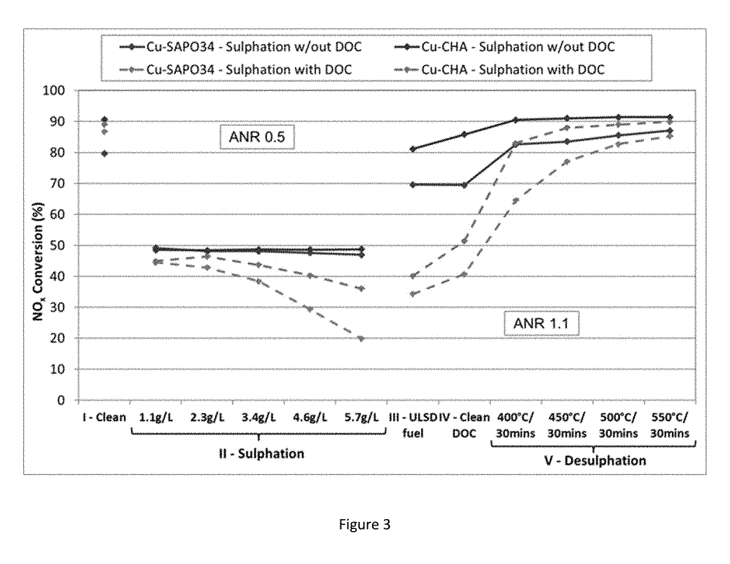

The test results are shown in FIG. 3. NOx conversion of the SCR catalysts was measured using ETC cycles. The sulfation step was completed with an ANR of 0.5 and the desulfation steps were completed with an ANR of 1.1. Sulfur exposure is quantified on the x-axis. Sulfation was completed using 25 consecutive ETC test cycles with LSD fuel, which corresponds to the sulfur exposures included on the graph in FIG. 3. For the desulfation steps, the catalysts were heated to 400° C. for 30 mins, then an ETC cycle was performed and the result of these cycles is shown. The average ETC temperature was 295° C.

As shown in the results plotted in FIG. 3, both catalysts exhibit significantly less deactivation (as represented by higher NOx conversion) as sulfur exposure increases, when there is not a DOC upstream of the Cu-SCR. Such results indicate that the systems without an oxidation catalyst upstream of the Cu-SCR exhibit excellent sulfur tolerance relative to the systems with an oxidation catalyst upstream of the Cu-SCR.

We claim:

1. An exhaust gas purification system comprising:
a. an injector for injecting ammonia or a compound decomposable to ammonia into the exhaust gas, positioned downstream of an engine;
b. a Cu-SCR catalyst positioned downstream of the urea/ammonia injector, wherein no oxidation catalysts exist between the Cu-SCR catalyst and the engine;
wherein the Cu-SCR catalyst comprises Cu exchanged SAPO-34, Cu exchanged CHA zeolite, Cu exchanged AEI zeolites, or combinations thereof.

2. The exhaust gas purification system of claim 1, further comprising a downstream system comprising one or more of a reductant injector, an SCR catalyst, an SCRF catalyst, a lean NOx trap, an ASC, a filter, an oxidation catalyst, SCRT and combinations thereof.

3. The exhaust gas purification system of claim 2, wherein the downstream system comprises two or more SCR catalysts.

4. The exhaust gas purification system of claim 1, further comprising an additional SCR catalyst upstream of the Cu-SCR catalyst.

5. The exhaust gas purification system of claim 1, wherein the exhaust gas entering the Cu-SCR catalyst comprises an NH₃/NOx ratio of less than 1.2.

6. The exhaust gas purification system of claim 1, wherein the exhaust gas entering the Cu-SCR catalyst comprises an NH₃/NOx ratio of about 0.4 to about 1.1.

7. A method of purifying exhaust gas, comprising:
a. adding ammonia or a compound decomposable into ammonia into the exhaust gas by an injector located downstream of an engine;
b. passing the exhaust gas through a Cu-SCR catalyst, wherein the Cu-SCR catalyst is positioned downstream of the injector and no oxidation catalysts exist between the Cu-SCR catalyst and the engine; and
wherein the amount of ammonia or of a compound decomposable to ammonia added to the exhaust gas stream in (a) is selected so that the exhaust gas entering the Cu-SCR catalyst has an NH₃/NOx ratio of less than 1.2.

8. The method of claim 7, wherein the amount of ammonia or of a compound decomposable to ammonia added to the exhaust gas stream in (a) is selected so that the exhaust gas entering the Cu-SCR catalyst has an NH₃/NOx ratio of about 0.4 to about 1.1.

9. The method of claim 7, wherein the Cu-SCR catalyst comprises Cu exchanged SAPO34, Cu exchanged CHA zeolite, Cu exchanged AEI zeolites, or combinations thereof.

10. The method of claim 7, wherein a rate of sulfation of the Cu-SCR catalyst is lower than a rate of sulfation of a Cu-SCR catalyst in an equivalent system except for comprising an oxidation catalyst upstream of the Cu-SCR catalyst.

11. The method of claim 7, wherein NOx conversion of the Cu-SCR catalyst is higher than NOx conversion of a Cu-SCR catalyst in an equivalent system except for comprising an oxidation catalyst upstream of the Cu-SCR catalyst.

12. The method of claim 7, wherein a rate of sulfation of the Cu-SCR catalyst is lower than a rate of sulfation of a Cu-SCR catalyst in an equivalent system except for having an exhaust gas entering the Cu-SCR catalyst that has an NH3/NOx ratio of 1.2 or greater.

13. The method of claim 7, wherein NOx conversion of the Cu-SCR catalyst is higher than NOx conversion of a Cu-SCR catalyst in an equivalent system except for having an exhaust gas entering the Cu-SCR catalyst that has an NH3/NOx ratio of 1.2 or greater.

14. The method of claim 7, further comprising passing the exhaust gas through an additional SCR catalyst upstream of the Cu-SCR catalyst.

15. The method of claim 7, further comprising passing the exhaust gas through a downstream system comprising one or more of a reductant injector, an SCR catalyst, an SCRF catalyst, a lean NOx trap, an ASC, a filter, an oxidation catalyst, SCRT and combinations thereof.

16. The method of claim 15, wherein the downstream system comprises two or more SCR catalysts.
